(19) United States
(12) Patent Application Publication
(10) Pub. No.: US 2007/0210599 A1
(43) Pub. Date: Sep. 13, 2007

(54) Retractable sliding cargo bed

(76) Inventor: Ronald Stewart Arnold, Edmonton (CA)

Correspondence Address: Ronald S. Arnold, 16211-89 Street, Edmonton, AB, T5Z-3M3, CA

(21) Appl. No.: 11/368,515

(22) Filed: Mar. 7, 2006

(51) Int. Cl. B65F 1/00

(52) U.S. Cl. 296/26.09; 296/26.01

(57) ABSTRACT

A retractable sliding cargo bed includes a stationary frame adapted for mounting onto a deck of a truck or other vehicle and a traveling frame that is movable relative to the stationary frame between a retracted position and an extended position. A locking mechanism is provided which includes stop-members secured to the bottom of the stationary frame at equally spaced intervals. A tandem-locking lever assembly is carried by the traveling frame, which is pivotally mounted for movement about an axis, which is parallel to the longitudinal axis of the traveling frame between a downwardly angled locking position and a substantially horizontal release position. The tandem-locking lever assembly is biased into the locking position. A release lever connected to an activation rod is provided for manually releasing and moving the tandem-locking lever assembly to the released and locked positions.

### REFERENCES

### U.S. Patent Documents Viewed

| | | | |
|---|---|---|---|
| 4,909,558 A | March 1990 | Roshinsky | 296/37.6 |
| 4,950,123 A | August 1990 | Brockhaus | 414/522 |
| 5,064,335 A | November 1991 | Bergeron et al. | 414/522 |
| 5,098,146 A | March 1002 | Albrecht et al. | |
| 5,513,941 A | May 1996 | Kulas et al. | 414/522 |
| 5,934,725 A | August 1999 | Bowers | 296/26.09 |
| 5,938,262 A | August 1999 | Mills | 296/26.09 |
| 6,065,792 A | May 2000 | Scuillo et al. | 295/26.09 |
| 6,120,075 A | September 2000 | Terry | 296/26.09 |
| 6,244,646 B1 | June 2001 | Wheeler, III | 296/26.01 |
| 6,318,780 B1 | November 2001 | St. Aubin | 296/26.09 |
| 6,328,364 B1 | December 2001 | Darbishire | 296/26.09 |
| 6,390,525 B2 | May 2002 | Carpenter et al. | 296.29.09 |
| 6,659,524 B1 | December 2003 | Carlson | |

### U.S. Patent Document References Cited

| | | | |
|---|---|---|---|
| 5,513,941 A | May 1996 | Kulas et al. | 414/522 |
| 6,659,524 B1 | December 2003 | Carlson | |

### FIELD OF INVENTION

The field of the present invention relates to a retractable sliding cargo bed of a truck, van or other similar vehicle.

### BACKGROUND OF THE INVENTION

U.S. Pat. No. 5,513,941 (Kulas et al 1996) and U.S. Pat. No. 6,659,524 (Carlson, 12/2003) are both examples of a retractable sliding cargo bed. Such retractable sliding cargo beds consist of a stationary frame, which is adapted for mounting to a deck of a truck, van or other similar vehicle, and a traveling frame, which slides along and within the stationary frame. It is important that retractable sliding cargo beds have a reliable locking mechanism, which prevents the uncontrolled movement of the traveling frame relative to the stationary frame. In the absence of a reliable locking mechanism, or the failure of an existing locking mechanism, the traveling frame could extend or retract uncontrollably. This is particularly the case when the truck or vehicle in which the retractable sliding cargo bed is mounted, is mobile or is parked on a hill and the traveling frame is heavily loaded. Should the traveling frame extend uncontrollably, a person could be struck and sustain injuries or the load could shift and be dislodged and cause an accident. In severe cases, a person could become crushed against a wall or another parked vehicle or be injured by the loaded items falling from the traveling frame.

The “Kulas et al” locking mechanism is somewhat effective and does lock the movement of the traveling frame, whereas, the “Carlson” design did provide some improvement to the “Kulas et al” design. The “Carlson” reference has a locking mechanism that consists of an activation rod, which travels from the first end of the traveling frame, through a series of drilled holes in all the transverse structural cross-members extending between the opposing sides of the traveling frame, to the second end of the traveling frame. The drilled holes in the cross members are positioned centrally and equally distant from the opposing sides and along the longitudinal axis of the traveling frame. The locking lever assembly that is rigidly affixed to the activation rod at the second end of the activation rod, is located adjacent to the second end of the traveling frame and the release lever that is rigidly affixed to the first end of the activation rod at the first end of the traveling frame and is located between the inside edge of the pull handle that is rigidly affixed to the first end of the traveling frame and the outside edge of the first end of the traveling frame at the first end of the traveling frame. Although this locking mechanism, as described and illustrated in the “Carlson”0 Patent reference, is better than some of the others referenced in the Patents, there is still room for improvement to the fundamental design of their retractable sliding cargo bed, including, but not limited to, the locking mechanism.

“Carlson et al” has, by drilling holes large enough to receive the activation rod longitudinally through the center of each of the transverse structural members that extend between the opposing sides of the traveling frame, created a fundamental weakening of the integral strength of the transverse structural members. The entire concept and reason behind the placement of these transverse structural members is to provide optimum strength to the traveling frame when it is carrying a load while either fully extended or fully retracted, but especially when fully extended. The “Carlson et al” locking lever assembly only engages one stop-member at a time and is completely reliant upon the biasing spring to provide enough rotational influence upon the activation rod to bring about the locking engagement. In the event of failure of the activation rod biasing spring, the locking lever assembly may fail to engage and may even be jolted out of engagement, should the vehicle be mobile and drive over a bump or pot-hole in the road. Also, the locking lever assembly only engages one stop-member and this may lend itself to disengagement in the event of the failure or breakage of the biasing spring for any reason. Also, with respect to the “Carlson et al” reference, when a person disengages the locking lever assembly by activating the release lever and then manually pulling the traveling frame, using the pull handle, in order to move the traveling frame from the retracted position to an extended position, it is easy to injure one's hand and/or fingers between the pull handle, the release lever and the tailgate or floorboards of the vehicle as the traveling frame passes over the tailgate or floorboards. This pinching of the fingers is due to the release lever being situated inside the area encompassed by the pull handle at the first end of the traveling frame and subsequently the fingers become pinched within the handle as the traveling frame passes over the tailgate or the floor-boards of the van. This is dangerous and can cause injury to the person operating the retractable sliding cargo bed, especially when retracting the traveling frame into the stationary frame.

### SUMMARY OF THE INVENTION

What is required is a retractable sliding cargo bed that is safer for the operator to use and has a release lever that is separated from and removed from the vicinity of the pull handle on the traveling frame. Also required as part of the traveling frame, is a locking mechanism that will simultaneously engage at least two locking points located on the stationary frame that will ensure that the traveling frame locking mechanism will never malfunction and will always engage at least two stop-members simultaneously, even in the event of the biasing spring failing for any reason. The “Carlson” locking mechanism that is located on the traveling frame engages only one of the stop-members on the bottom of the stationary frame and the stationary frame routinely flexes in the middle across the transverse cross section between the opposing sides of the stationary frame, when the cargo bed is fully extended with the maximum load applied to the cargo bed. Vehicle's being driven while the retractable sliding cargo bed is fully extended is a common practice on constructions sites and the need for safety is ever-present. Therefore, for the purpose of enhancing the safety concerns as described above, the necessary provisions to alleviate the above-mentioned concerns has been addressed in our present invention.

According to the present invention, there is provided a retractable sliding cargo bed, which includes a stationary frame adapted for mounting onto a truck, van or other similar and/or appropriate vehicle. The stationary frame has a first end, a second end, a bottom and opposed sides having guide channels. A traveling frame is provided having a first end, a second end and opposing sides. The traveling frame is received wit the stationary frame with the opposed sides of the traveling frame engaging the guide channels on the opposed sides of the stationary frame. The traveling frame is movable relative to the stationary frame between a retracted position and an extended position. A tandem-locking mechanism is provided for controlling the travel of the traveling frame along and within the stationary fame, which includes fabricated and formed and vertically inclined stop-members rigidly affixed at equally spaced intervals from the first end to the second end of the stationary frame on a structural member which is longitudinally and rigidly affixed to the bottom of the stationary frame. A tandem-locking lever assembly is rigidly affixed to the second end of the activation rod, which in turn, is carried on the traveling frame and the activation rod is pivotally mounted for movement about an axis, which is parallel to the longitudinal axis of the traveling frame between a downward angled locking position and a substantially horizontal release position. A means is provided to bias the tandem-locking lever assembly into the locking position whereby the tandem-locking lever assembly simultaneously engages two of the stop-members which are rigidly affixed to the bottom of the stationary frame. A release lever is provided at the first end of the traveling frame for manually moving the tandem-locking lever assembly to a released position.

The retractable sliding cargo bed, as described above, with a tandem-locking lever assembly that engages two stop-members simultaneously, which are rigidly affixed to the bottom of the stationary frame, provides safe, consistent and secure dual locking engagement in either a retracting or extending direction, under a normal, heavy and/or maximum load, even in the event of the failure of the biasing spring.

Although beneficial results may be obtained through the use of a retractable sliding cargo bed, as described above, it is preferred that the locking mechanism include an activation rod which extends from the first end to the second end of the traveling frame. The activation rod has a first end positioned adjacent to the first end of the traveling frame and a second end positioned adjacent to the second end of the traveling frame. The activation rod has a longitudinal axis and is mounted to the traveling frame for rotation about the longitudinal axis. The release lever is rigidly affixed to the first end of the activation rod. The tandem-locking lever assembly is rigidly affixed to the second end of the activation rod.

Although beneficial results may be obtained through the use of the retractable sliding cargo bed, as described above, the more rigid the activation rod can be maintained along its longitudinal axis, from its first end to its second end, the better the locking mechanism will work. Even more beneficial results may therefore be obtained when a plurality of transverse structural cross-members extend between the opposed sides of the traveling frame and the activation rod passes through its own dedicated series of steel guide supports, which are rigidly affixed to the underside of the transverse structural cross members which extend between the opposed sides of the traveling frame in a manner which does not effect the structural integrity of the transverse structural members.

Although beneficial results way be obtained through the use of the retractable sliding cargo bed, as described above, the rigid affixing of the activation rod steel support guides along the longitudinal axis of the traveling frame, onto the underside of the transverse structural cross-members of the traveling frame, which extend between the opposing sides of the traveling frame and are equally spaced from the first end to the second end of the traveling frame, ensures that the maximum structural integrity of the transverse cross-members extending between the opposed sides of the traveling frame is fully maintained and thereby ensures that the traveling frame is capable of carrying not only it's maximum load safely, but that the tandem-locking lever mechanism will perform perfectly and safely at all times.

Although beneficial results may be obtained through the use of the retractable sliding cargo bed, as described above, the preferred means of biasing the tandem-locking lever assembly into the dual locking position, is through the use of a spring. It is preferred that the spring exerts a rotational force upon the activation rod to urge the tandem-locking lever assembly into the dual locking position.

Although beneficial results may be obtained through the use of the retractable sliding cargo bed, as described above, in the event of the biasing spring failing to exert enough rotational force upon the activation rod to bring about the tandem-locking lever assembly simultaneously engaging with two of the stop-members affixed to the bottom of the stationary frame and thereby into a safe double-locked position, or in the event of the spring breaking completely, the physical weight of the tandem-locking lever assembly alone is more than is required to exert enough rotational force upon the activation rod to ensure consistent and complete engagement with the stop-members which are rigidly affixed at equally spaced intervals on the structural member that is, in turn, longitudinally and rigidly affixed to the bottom of the stationary frame, thereby preventing the traveling frame from moving in an uncontrolled manner in either a retracting or an extending motion.

Although beneficial results may be obtained through the use of the retractable sliding cargo bed, as described above, the position of the release lever at the first end of the activation rod is much safer to use when located to the side of, and away from the pull handle which is located at the first end of the traveling frame instead of inside the framework of the pull handle and the potential for injury to fingers and/or hands of those person's operating the retractable sliding cargo bed is thereby eliminated.

Although beneficial results may be obtained through the use of the retractable sliding cargo bed, as described above, even more beneficial results may be obtained if the activation rod, which has its first end located at the first end of the traveling frame and its second end located at the second end of the traveling frame, and the activation rod support guides, rigidly affixed to the underside of the transverse structural cross members which extend between the opposing sides of the traveling frame, and the tandem-locking lever assembly and all components of the locking mechanism forming part of the traveling frame, when situated and affixed to the traveling frame, are all in complete and perfect alignment along the longitudinal axis of the traveling frame.

Although beneficial results may be obtained through the use of the retractable sliding cargo bed, as described above, when all of the stop-members are rigidly affixed on the bottom of the stationary frame at equally spaced intervals on a longitudinal axis from the first end of the stationary frame to the second end of the stationary frame and are designed to engage the tandem-locking lever assembly located at the second end of the traveling frame, and the above mentioned stop-members are located appropriately below the traveling frame and the tandem-locking lever assembly located at the second end of the traveling frame, the correct simultaneous locking engagement of the tandem-locking lever assembly located on the traveling frame, with two of the stop-members located on the bottom of the stationary fame, occurs when activated by the biasing spring connected to the activation rod located on the traveling frame.

Although beneficial results may be obtained through the use of the retractable sliding cargo bed, as described above, even more beneficial results may be obtained when the opposing sides of the stationary frame are reinforced along their complete length and height with the addition of a steel flat bar that is equal to the thickness of, or thicker than, the original thickness of the opposing sides of the stationary frame.

Although beneficial results may be obtained through the use of the retractable sliding cargo bed, as described above, even more beneficial results may be obtained when the opposing side guide channels of the stationary frame each have a top plate and a bottom plate that extend along the longitudinal length of each of the opposing sides of the stationary frame. In the present invention, each opposing side guide channel has a top plate which extends from the second end to within approximately a few inches of the fist end of each of the opposing sides of the guide channels of the stationary frame, and the traveling frame has a top roller at the second end of the traveling frame that engages the top plate of the stationary frame and a bottom roller at the second end of the traveling frame that engages the bottom plate of the stationary frame.

Although beneficial results may be obtained, as described above, through the use of the retractable sliding cargo bed, even more beneficial results may be obtained when each of the opposing sides of the traveling frame consist of an angle iron that extends from the first end of the opposing sides of the traveling frame to the second end of the opposing sides of the traveling frame. The angle iron's both being so situated, then engage and overlie the support roller secured to the first end of each of the opposing sides of the stationary frame side channels. These support rollers are located, each on the opposing side of the first end of the stationary frame opposing side channels to provide frontal support to the traveling frame as it travels along and within the longitudinal length of the stationary frame opposing side channels. A small portion of the length of the top plate at the first end of the opposing side channels of the stationary frame is removed, as previously described above, a few inches from the first end of each the opposing side channels and immediately above the support rollers each located at the first end of the stationary frame opposing side channels. This allows for the rollers situated at the first end of the stationary Frame to be raised and positioned high enough to engage the underside of the angle iron's which are herein referred to as the opposing sides of the traveling frame and to thereby provide frontal support to the traveling frame as it travels along the longitudinal length of the stationary frame. When the traveling frame is fully extended from within the stationary frame, it is supported by the top and bottom rollers situated at the second end of the opposing sides of the traveling frame simultaneously with the support roller situated at the first end of the opposing sides of the stationary frame. With this construction design, the traveling frame is completely supported when either filly retracted or fully extended and will travel smoothly at all times due to being supported at both the first end of the stationary frame and the second end of the traveling frame simultaneously.

Although beneficial results may be obtained, through the use of the retractable sliding cargo bed, as described above, an additional reason for the removal of a short section of the top plates of the opposing sides of the stationary frame guide channels immediately above the support rollers at the first end of the opposing sides of the stationary frame, is to allow for the removal of the traveling frame from the stationary frame. This is accomplished by manually disengaging the tandem-locking lever assembly and holding it in that position, through the manipulation of the release lever located at the first end of the traveling frame and by pulling the traveling frame by gripping and pulling the pull handle secured to the first end of the traveling frame, to move the traveling frame to a filly extended position and thereby allowing the tandem-locking lever assembly on the traveling frame to bypass the last two stop-members affixed to the bottom of the stationary frame at the first end of the stationary frame, which in turn, allows for the top roller and bottom roller located on the opposing sides of the traveling frame to pass into the area of the stationary frame where the section of the top plate has been removed on the stationary frame opposing side guide channels at the first end of the stationary frame, and thereby allowing for the easy removal of the traveling frame simply by lifting it out of the opposing guide channels of the stationary frame.

Although beneficial results may be obtained, through the use of the retractable sliding cargo bed, as described above, even more and noticeable beneficial results may be obtained when the opposing sides of the traveling frame, as previously described, engage the support rollers situated on the opposing sides of the stationary frame at the first end of the stationary frame, thereby providing additional and dramatic clearance between the traveling frame and the tailgate of the truck or deck of the vehicle is realized due to the elimination of the problem of the traveling frame pitching forward and downward when being fully extended. Even more beneficial results may be obtained with the proper positioning of the support roller on each side of the first end of the stationary frame, as previously described above, and specifically in relation to how high or low the so described support roller is placed, as this proper placement will provide more, or less, clearance to the traveling frame as it passes over the tailgate or the deck of the vehicle it is attached to. The higher the placement of the support roller located on the first end of the opposing sides of the stationary frame, the more clearance is achieved between the tailgate and/or the deck of the vehicle by the traveling frame and conversely, the lower the placement of the support roller, the less clearance is achieved between the tailgate and/or the deck of the vehicle by the traveling frame.

### BRIEF DESCRIPTION OF THE DRAWINGS

These and other features of the invention will become more apparent from the following description in which reference is made to the appended drawings. The drawings are for the purpose of illustration only and are not intended to in any way limit the scope of the invention to the particular embodiment or embodiments shown herein:

FIG. 1 is a perspective view of the retractable sliding cargo bed constructed in accordance with the teachings of the present invention, in the extended position.

FIG. 2 is a perspective view of the retractable sliding cargo bed as illustrated in FIG. 1 in a retracted position.

FIG. 3 is a perspective view of the stationary fame of the retractable sliding cargo bed as illustrated in FIG. 1.

FIG. 4 is a perspective detailed view of the traveling frame of the retractable sliding cargo bed as illustrated in FIG. 1.

FIG. 5 is a side elevation view of the traveling frame of the retractable sliding cargo bed as illustrated in FIG. 4.

FIG. 6 is an end elevation view of the traveling frame of the retractable sliding cargo bed as illustrated in FIG. 4.

FIG. 7 is a side elevation view of the equally spaced and vertically inclined stop-members which are rigidly affixed to the structural member that is, in turn, rigidly and longitudinally affixed to the bottom of the stationary frame as illustrated in FIG. 3.

### DETAILED DESCRIPTION OF THE PREFERRED EMBODIMENT

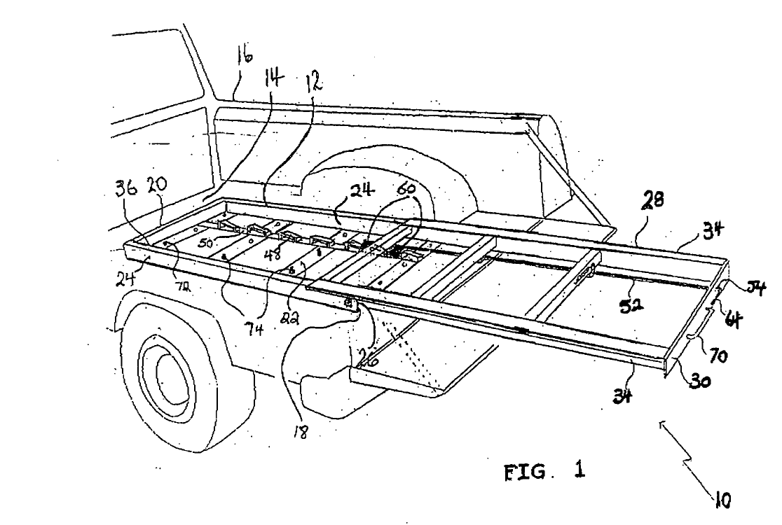

The preferred embodiment, a retractable sliding cargo bed generally identified by reference numeral 10, will now be described with reference to FIGS. 1 through 5.

### Structure and relationship of Parts:

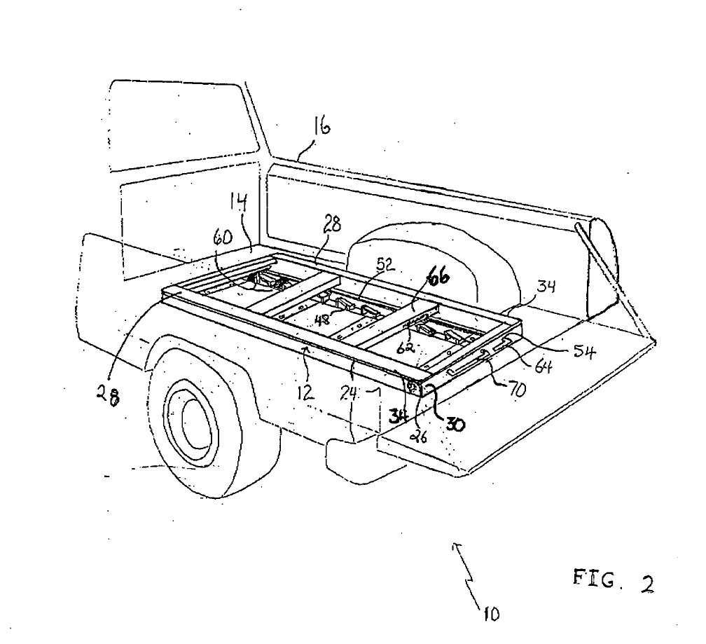

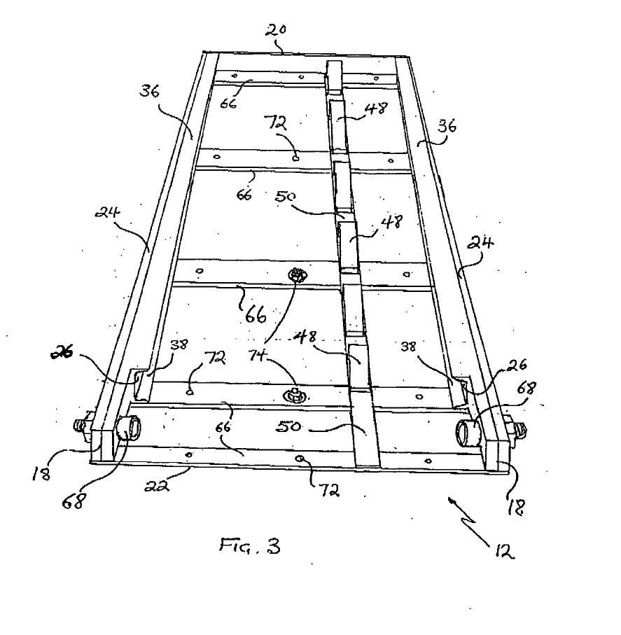

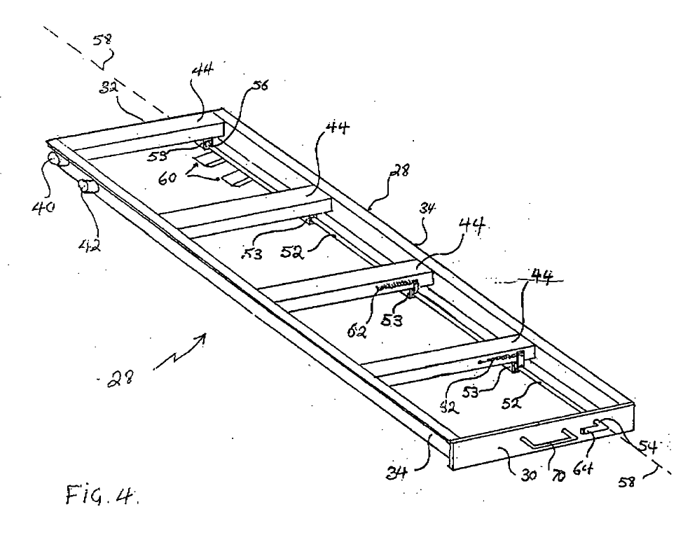

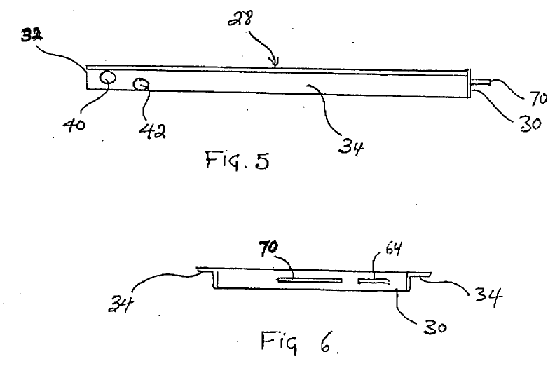

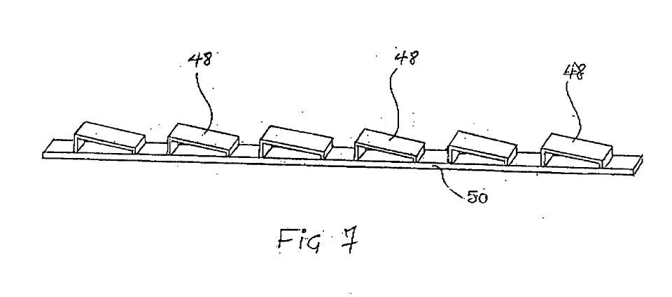

Referring to FIG. 1, retractable sliding cargo bed (10) includes a stationary frame (12) adapted for mounting onto a deck (14) of a truck (16). Referring to FIG. 3, stationary frame (12) has a first end (18), a second end (20), a bottom (22), and opposed sides (24), which have, guide channels (26). Referring to FIG. 4, a traveling frame (28) is provided that has a first end (30), a second end (32) and opposed sides (34). Referring to FIG. 1, traveling frame (28) is received within stationary frame (12) with opposed sides (34) of traveling frame (28) engaging guide channels (26) on opposed sides (24) of stationary frame (12). Referring to FIG. 3, guide channels (26) of stationary frame (12) have a top plate (36) and a bottom plate (38). Referring to FIG. 5, traveling Same (28) has a top roller (40) at the second end (32) that engages top plate (36) illustrated in FIG. 3 and a bottom roller (42) at the second end (32) that engages the bottom plate (38) illustrated in FIG. 3, in such a way that the second end (32) of the traveling frame (28) is supported both top and bottom to reduce risk of pitching forward and downward when fully extended as illustrated in FIG. 1. Referring to FIG. 4, a plurality of transverse structural members (44), extend between opposed sides (34) of traveling frame (28). Referring to FIG'S. 1 and 2, traveling frame (28) is movable relative to stationary frame (12), between being fully retracted as illustrated in FIG. 2, and fully extended, as illustrated in FIG. 1. Referring to FIG. 4, the traveling frame (28) has outwardly extending angle iron opposing sides (34) of the traveling frame and are designed to provide support to the traveling frame (28) through their constant contact with the rollers (68) as illustrated in FIG. 3, affixed to the first end (18) of the stationary frame (12) and to facilitate smooth traveling of the traveling frame (28) illustrated in FIG. 4. These outwardly extending angle iron opposing sides (34) of the traveling frame (28) overlay on the rollers (68) affixed to the first end of the stationary frame (12) in order to provide further stability along the longitudinal axis of the retractable sliding cargo bed to the retractable sliding cargo bed (10) as it extends and retracts.

Referring to FIG. 1, a tandem-locking lever assembly generally referenced by numeral (60) is provided for controlling the travel of the traveling frame (28) along and within the stationary frame (12). Referring to FIG'S. 3 and 7, fabricated metal stop-members (48) which are equally spaced, vertically inclined and rigidly affixed onto a longitudinally and also rigidly affixed structural member (50) that is longitudinally affixed, slightly off-center along the bottom (22) of the stationary frame (12) at spaced intervals from the first end (18) to the second end (20) of the stationary frame (12). Referring to FIG. 4, an activation rod (52) extends from the first end (30) to the second end (32) of the traveling frame (28). Activation rod (52) extends through and is supported by steel guide-tubes (53) that are rigidly affixed to the transverse structural cross members (44) of the traveling frame (28). Activation rod (52) has a first end (54) positioned adjacent to the first end (30) of the traveling frame (28) and a second end (56) positioned adjacent to the second end (32) of the traveling frame (28). Activation rod (52) has a longitudinal axis (58) and is mounted to the traveling frame (28) for rotation about the longitudinal axis (58). A tandem-locking lever assembly (60) is rigidly affixed to the second end (56) of the activation rod (52), so that upon rotation of the activation rod (52), tandem-locking lever assembly (60) is moved between a downwardly angled locking position and a substantially horizontal release position. Referring to FIG'S. 1 and 7, the vertically inclined positioning of the stop-members (48) which are rigidly affixed to the longitudinal structural member (50) on the bottom of the stationary frame (12) is designed to force the tandem-locking lever assembly (60) to engage two stop-members (48) simultaneously and consistently at all times, whether the traveling frame (28) is being retracted or extended and to simultaneously serve to forcibly guide the tandem-locking lever assembly (60) to make contact with the longitudinally affixed structural member (50) rigidly affixed to the bottom (22) of the stationary frame (12) while being prevented from movement by the stop-members (48) rigidly affixed the bottom structural member (50) on the bottom (22) of the stationary frame (12). Referring to FIG. 4, springs (62) act upon the activation rod (52) to bias the tandem-locking lever assembly (60) into a locking position whereby the tandem-locking lever assembly (60) engages two of the vertically inclined positioned stop-members (48) simultaneously, which are rigidly affixed to the longitudinally affixed structural member (50) of the stationary frame (12) as illustrated in FIG'S, 3 and 7. Referring to FIG. 4, a release lever (64) is secured to the first end (54) of the activation rod (52) for the manual rotation of the activation rod (52) to facilitate the movement of the tandem-locking lever assembly (60) from a locked position to a released position Referring to FIG. 3, rigidly affixed reinforcing cross-members (66) are attached to the underside of the stationary frame (12) between the opposing sides (24) of the stationary frame (12) to prevent twisting of the stationary frame (12) when the traveling frame (28) is fully extended as illustrated in FIG 1. Referring to FIG. 3, rollers (68) are provided on the first end (18) of the stationary frame (12) to facilitate travel of the traveling frame (28) illustrated in FIG. 4, when the traveling frame is being moved relative to the stationary frame (12). Referring to FIG. 1, a pull-handle (70) is provided at the first end (30) of the traveling frame (28) for the purpose of manually gripping and pulling the traveling frame (28) in order to extend or retract the traveling frame (28). Referring to FIG. 3, holes (72) are drilled through the reinforcing cross-members (66) that are attached to the underside of the stationary frame (12) transversely between the opposing sides (24) of the stationary frame (12) to allow for the affixing of the stationary frame (12), with appropriately sized fasteners (74) to the deck (14) of the truck (16) as illustrated in FIG. 1.

### Operation

The use and operation of the retractable sliding cargo bed, as generally identified by reference numeral (10), will now be described with reference to FIG'S. 1 through 7. Referring to FIG. 1, retractable sliding cargo bed (10) is mounted to a deck (14) of a truck (16) by fasteners (74), which, are inserted through the drilled holes (72) in the bottom (22) of the stationary frame (12) as illustrated in FIG. 3, to secure the stationary fame (12) to the deck (14) of the truck (16) While the illustrated embodiment shows the retractable sliding cargo bed (10) mounted to the deck (14) of the truck (16), it will be appreciated that the retractable sliding cargo bed (10) could easily be installed in a variety of other vehicles, such as vans, suburban's, SUV's, service bodies and a variety of emergency vehicles as well as recreational vehicles. The retractable sliding cargo bed (10) can also be adapted for installation to accommodate stationary equipment such as found in gas plants, industrial complexes and hospitals, to name only a few potential applications.

Referring to FIG. 2, once the stationary fame (12) has been secured to the deck (14) of the truck (16), the traveling frame (28) is received within the stationary frame (12) with the opposed sides (34) of the traveling frame (28) engaging the guide channels (26) on the opposed sides (24) of the stationary frame (12).

Referring to FIG'S 1 and 4, release lever (64) at the first end (54) of the activation rod (52) is rotated to rotate the activation rod (52), which moves the tandem-locking lever assembly (60) to a substantially horizontal release position. Referring to FIG. 1, by manually gripping the pull handle (70) the operator can then manually move the traveling frame (28) relative to the stationary frame (12) between a retracted position illustrated in FIG.2, and extended position illustrated in FIG. 1. Referring to FIG. 1, when traveling frame (28) has been moved to the desired extended position, release lever (64) at the first end (54) of the activation rod (52) is released so that the activation rod (52), which moves the tandem-locking lever assembly (60), rotates so that the tandem-locking lever assembly (60) moves to the downwardly angled locking position. Springs (62) act upon the activation rod (52) to bias the tandem-locking lever assembly (60) into the locking position, whereby the tandem-locking lever assembly (60) simultaneously engages two of the metal stop-members (48) rigidly affixed to the structural member (50) which is, in turn, rigidly affixed to the bottom (22) of the stationary frame (12).

Referring to FIG. 5, top roller (40) at the second end (32) of the traveling frame (28) that engages the top plate (36) of the stationary frame (12) illustrated in FIG. 3, and the bottom roller (42) at the second end (32) of the traveling frame (28) that engages the bottom plate (38) of the stationary frame (12) illustrated in FIG. 3, ensure that the traveling frame (28) is supported both top and bottom to reduce downwardly pitched movement when in a fully extended position as illustrated in FIG. 1.

Referring to FIG.'S 1 and 4, the traveling fame (28) has outwardly extending rigidly affixed angle iron opposing sides (34) of the traveling frame (28) as illustrated in FIG'S 1 and 4, to engage the rollers (68) at the first end (18) of the stationary frame (12) as illustrated in FIG. 3, and this lends stability to the entire operation of the retractable sliding cargo bed.

Referring to FIG. 2, when it becomes desirable to move the traveling frame (28) to the retracted position, as illustrated in FIG. 2, the release lever (64) at the first end (54) of the activation rod (52) can be used to rotate the activation rod (52), which will move the tandem-locking lever assembly (60) to a substantially horizontal release position. Should the traveling frame (28) begin to gain momentum due to positioning the vehicle on an incline, for example, the biasing springs (62) will urge the tandem-locking lever assembly (60) back into the dual locking position, thereby stopping the movement of the traveling frame (28). Should the biasing spring (62) fail or break for any reason, the tandem-locking lever assembly (60) will automatically seek the next two locking positions wit the stop-members (48) and lock into place due to the advantage of the physical weight of the tandem-locking lever assembly (60) biasing itself into the locking position, coupled with the vertical incline of the stop-members (48) which guide the tandem-locking lever assembly (60) into a dual locking position automatically.

In this Patent Document, the word “comprising” is used in its non-limiting sense, to mean that items following the word are included, but items not specifically mentioned are not excluded. A reference to an element by the indefinite article “a” does not exclude the possibility that more than one of the element's are present, unless the context clearly requires that there be one and only one of the elements.

It will be apparent to one skilled in the art that modifications may be made to the illustrated embodiment without departing from the spirit and scope of the invention as hereinafter defined in the Claims.

1. A retractable sliding cargo bed, comprising of:
a stationary frame adapted for mounting onto a deck of a truck, the station fame having a first end, a second end, a bottom, opposed sides having guide channels, a non-centrally located longitudinal structural member extending between the opposed sides from the first end to the second end;
a traveling fame having a first end, a second end and opposed sides, the traveling Fame being received within the stationary frame with the opposed sides of the traveling frame engaging the guide channels on the opposed sides of the stationary frame and the outwardly facing angle iron opposing sides of the traveling frame overlaying and engaging the rollers secured to the first end of the stationary frame, the traveling frame being movable relative to the stationary frame between a retracted position and an extended position;
a locking mechanism for controlling the travel of the traveling frame within the stationary frame, the locking mechanism engaging vertically inclined stop-members rigidly affixed and spaced at equally distant intervals along a non-centrally longitudinally positioned structural member on the bottom of the stationary frame;
a tandem-locking lever assembly carried by the traveling frame, the tandem-locking lever assembly being pivotally mounted for movement about an axis which is parallel to the longitudinal axis of the traveling frame between a downwardly angled locking position and a substantially horizontal release position;
an activation rod pivotally mounted for movement about a longitudinal axis which is parallel to the longitudinal axis of the traveling frame, and has a first end adjacent to the first end of the traveling frame and a second end adjacent to the second end of the traveling frame, and has the tandem-locking lever assembly rigidly affixed to the second end of the activation rod and a release lever rigidly affixed to or forming part of the first end of the activation rod;
a means for biasing the activation rod about its axis in order to engage the tandem-locking lever assembly rigidly affixed to the second end of the activation rod into the locking position whereby the tandem-locking lever assembly simultaneously engages two of the stop-members rigidly affixed to a structural member that is both longitudinally aligned non-centrally to the longitudinal axis of the stationary frame and also rigidly affixed to the bottom of the stationary frame;
a release lever rigidly affixed to, or forming part of, the first end of the activation rod adjacent to the first end of the traveling frame for manually moving the tandem-locking lever assembly to a released position.

2. The retractable sliding cargo bed as defined in claim 1, wherein an activation rod extends from the first end to the second end of the traveling frame, the activation rod having a first end positioned adjacent to the first end of the traveling frame and a second end positioned adjacent to the second end of the traveling frame, the activation rod having a longitudinal axis parallel to the longitudinal axis of the traveling frame and being mounted to the traveling frame for rotation about the longitudinal axis of the activation rod, with the release lever secured to, or forming part of, the first end of the activation rod and the tandem-locking lever assembly secured to the second end of the activation rod.

3. The retractable sliding cargo bed as defined in claim 2, wherein a plurality of equally spaced transverse structural members extend between the opposed sides of the traveling frame and the activation rod extends along the longitudinal axis of the traveling frame from the first end to the second end of the traveling frame and passes through a series of steel tubes which are longitudinally aligned with the longitudinal axis of the traveling frame and are rigidly affixed to the underside of the transverse structural members which extend between the opposing sides of the traveling frame.

4. The retractable sliding cargo bed as defined in claim 1, wherein the means for biasing the tandem-locking lever assembly into the dual locking position is a spring.

5. The retractable sliding cargo bed, as defined in claim 1, wherein the biasing effect on the activation rod is provided by the force imposed by the constant influence of the spring, however, should the spring fail or break, the physical weight of the tandem-locking lever assembly will immediately force the tandem-locking lever assembly to engage the closest two stop-members rigidly affixed to the non-centrally longitudinally aligned and rigidly affixed structural member on the bottom of the stationary frame.

6. The retractable sliding cargo bed as defined in claim 1, wherein stop-members are fabricated metal plates vertically inclined and rigidly affixed to the structural member that is rigidly affixed to the bottom of the stationary frame in such a way that the stop members automatically guide the tandem-locking lever assembly carried by the traveling frame, into a locking position simultaneously against two of the stop-members affixed to the longitudinally aligned structural member rigidly affixed to the bottom of the stationary frame.

7. The retractable sliding cargo bed as defined in Claim 1, wherein the rigidifying reinforcing members extend down the outside length of the opposed sides of the stationary frame.

8. The retractable sliding cargo bed as defined in claim 1, wherein the guide channels of the stationary fame have a top plate and a bottom plate, the traveling frame has a top roller at the second end of the traveling frame that engages the top plate of the stationary frame and a bottom roller at the second end of the traveling frame that engages the bottom plate of the stationary frame, so that the second end of the traveling frame is fully supported top and bottom when in the extended position.

9. A retractable sliding cargo bed, comprising of:
a stationary frame adapted for mounting onto a deck of a truck, the stationary frame having a first end, a second end, a bottom and opposed sides having guide channels;
a traveling frame having a first end, a second end and opposed sides, the opposed sides being reinforced angle iron with outwardly extending side flanges, the traveling frame being received within the stationary frame and engaging the guide channels on the opposed sides of the stationary frame, a plurality of equally spaced transverse structural members extending between the opposed sides of the traveling frame, the traveling frame being movable relative to the stationary frame between a retracted position and an extended position;
a locking mechanism for controlling the travel of the traveling frame along and within the stationary frame, the locking mechanism including;
stop-members secured to the non-centrally positioned longitudinally affixed structural member rigidly affixed to the bottom of the stationary frame at spaced intervals from the first end to the second end of the stationary frame;
an activation rod extending along a longitudinal axis from the first end to the second end of the traveling frame, the activation rod extending through steel tubes rigidly affixed to the underside of the transverse structural members that extend between the opposing sides of the traveling frame, the activation rod having a first end positioned adjacent to the first end of the traveling frame and a second end positioned adjacent to the second end of the traveling frame, the activation rod having a longitudinal axis and being mounted to the traveling frame for rotation about the longitudinal axis;
a tandem-locking lever assembly rigidly affixed to the second end of the activation rod, upon rotation of the activation rod the tandem-locking lever assembly being moved between a downwardly angled locking position and a substantially horizontal release position;
a spring acting upon the activation rod to bias the tandem-locking lever assembly into the locking position whereby the tandem-locking lever assembly simultaneously engages two of the stop-members rigidly affixed to the bottom of the stationary frame; and
a release lever rigidly affixed to the fir end of the activation rod for manually rotating the activation rod to move the tandem-locking lever assembly to the release position.

10. The retractable sliding cargo bed as defined in claim 9, wherein the stop-members are fabricated metal plates vertically inclined and mounted in a mariner to guide the tandem-locking lever assembly consistently into a dual locking position.

11. The retractable sliding cargo bed as defined in claim 9, wherein the stop-members are equally spaced and rigidly affixed to a non-centrally located longitudinally positioned structural member rigidly affixed to the bottom of the stationary frame;

12. The retractable sliding cargo bed as defined in claim 7, wherein rigidifying reinforcing members extend down the outside of the opposed sides of the stationary frame.

13. The retractable sliding cargo bed as defined in Claim 8, wherein the guide channels of the stationary frame have a top plate and a bottom plate, and the traveling frame has a top roller at the second end that engages the top plate of the stationary frame and a bottom roller at the second end that engages the bottom plate of the stationary frame, such that the second end of the traveling frame is fully supported top and bottom when in the extended position.

14. A retractable sliding cargo bed, comprising of;
a stationary frame adapted for mounting onto the deck of a truck, a van or similar vehicle, the stationary frame having a first end, a second end, a bottom and opposed sides having guide channels, and support rollers attached and secured to the first end of the stationary frame to provide support to the traveling frame when the traveling frame is being retracted or extended within the stationary frame;
a traveling frame having a first end, a second end aid opposed sides, with the opposed sides of the traveling fame each consisting of an angle iron with outwardly extending side flanges to provide support to the traveling frame when the flanges of the angle irons engage the rollers secured to the first end of the stationary frame, the traveling frame being received within the guide channels on the opposed sides of the stationary frame, a plurality of transverse structural members extending between the opposed sides of the traveling frame, the traveling frame being movable relative to the stationary frame between a retracted position and an extended position;
a locking mechanism for controlling travel of the traveling frame along and within the stationary frame, the locking mechanism including;
equally spaced stop-members secured to a non-centrally located longitudinally positioned structural member on the bottom of the stationary structural member positioned longitudinally and non-centrally between the first end and the second end on the stationary frame, the stop-members being in the form of formed metal structures equally spaced and rigidly affixed to the longitudinally positioned structural member at the bottom of the stationary frame;
an activation rod extending from the first end to the second end of the traveling frame, the activation rod extending through and supported by steel tubes rigidly affixed and aligned to the underside of the transverse structural members of the traveling frame, the activation rod having a first end positioned adjacent to the first end of the traveling frame and a second end positioned adjacent to the second end of the traveling frame, the activation rod having a longitudinal axis and being mounted to the traveling frame parallel to the longitudinal axis of the traveling frame for rotation about its longitudinal axis;
a tandem-locking lever assembly rigidly affixed to the second end of the activation rod, upon rotation of the activation rod the tandem-locking lever assembly being moved between a downwardly angled locking position and a substantially horizontal release position, the vertical orientation of the stop-members guiding the tandem-locking lever against the non-centrally positioned longitudinal structural member rigidly affixed to the bottom of the stationary frame;
a spring acting upon the activation rod to bias the tandem-locking lever assembly into a locking position whereby the tandem-locking lever assembly simultaneously engages two of the stop-members secured to the bottom of the stationary frame; and
a release lever rigidly affixed to the first end of the activation rod for manually rotating the activation rod to move the tandem-locking lever to the release position.

15. The retractable sliding cargo bed as defined in claim 12, wherein rigidifying reinforcing members extend down the opposed sides of the stationary frame, from the first end to the second end of the stationary frame, thereby preventing twisting of the stationary frame when the traveling frame is fully extended under load.

16. The retractable sliding cargo bed, as defined in claim 13, wherein the guide channels of the stationary frame have a top plate and a bottom plate, and the traveling frame has a top roller at the second end that engages the top plate and a bottom roller at the second end that engages the bottom plate, such that the second end of the traveling frame is supported both top and bottom to reduce pitching forward and downward movement of the traveling fame when the traveling frame is in the extended position.

17. The retractable sliding cargo bed as defined in claim 14, wherein the traveling frame has reinforced angle iron opposing sides and the angle iron has outwardly extending side flanges that overlie the rollers attached to the first end of the stationary frame which provide support and smooth operational movement of the traveling frame within the stationary frame when the traveling frame is being retracted or extended.
